(19) United States
(12) Patent Application Publication
(10) Pub. No.: US 2026/0062642 A1
(43) Pub. Date: Mar. 5, 2026

(54) SPOONABLE OIL PRODUCT COMPRISING STABLE POLYUNSATURATED FATTY ACID

(71) Applicant: SOCIÉTÉ DES PRODUITS NESTLÉ S.A., Vevey (CH)

(72) Inventors: Jwanro HUSSON, Lausanne 25 (CH); Lucille ROTA LEPAGNOL, Radolfzell (DE); Beate PFEIFFER, Gailingen (DE); Lilian BARRO, La ville Aux Dames (FR)

(21) Appl. No.: 19/106,908

(22) PCT Filed: Aug. 30, 2023
(86) PCT No.: PCT/EP2023/073746

§ 371 Date: Feb. 26, 2025

(30) Foreign Application Priority Data
Aug. 31, 2022 (EP) 22193231.2

(51) Int. Cl. C11B 1/14; C11B 3/00; C11B 3/16

(52) U.S. Cl. CPC C11B 1/14; C11B 3/001; C11B 3/008; C11B 3/16

(57) ABSTRACT

The invention relates to a method of making an oil product, said method comprising: (i) forming a suspension of flax seed hemp, or chia in water, (ii) heat treating the suspension; (iii) reducing the particle size of the suspension, for example by grinding; (iv) optionally adjusting the suspension pH to between pH 7 to 8, or to about pH 7.5; (v) filtering the suspension and (vi) adjusting the suspension pH to between pH 2 to 3.5, or about pH 2.5; and (vii) obtaining a retentate, preferably by centrifuging; and (viii) adding the retentate to a melted fat or melted fat blend to form an oil product.

### INTRODUCTION

Cooking oils are used worldwide to make many different kinds of culinary dishes. Such oils very often have a poor nutritional value, and therefore fail to meet consumer needs. To try and address this issue, some cooking oils have been supplemented with polyunsaturated fatty acids to improve their nutritional score. The disadvantage of this approach is that the cooking oils also need to contain additives such as antioxidants and emulsifiers to help prevent oxidation problems and off flavor issues.

There is a clear need for new, clean label solutions for cooking oils that perform equally well in the pan, but address the nutritional needs of the consumer and help prevent unwanted oxidation and off flavors.

### SUMMARY OF THE INVENTION

The invention relates in general to a method of making an oil product, said method comprising forming a suspension of oilseeds, for example flax seed, hemp, or chia in liquid.

The invention further relates to a method of making an oil product, said method comprising: (i) forming a suspension of flax seed, hemp, or chia in water; (ii) heat treating the suspension; and (iii) reducing the particle size of the suspension, for example by grinding.

The invention further relates to a method of making an oil product, said method comprising: (i) forming a suspension of flax seed, hemp, or chia in water; (ii) heat treating the suspension; (iii) reducing the particle size of the suspension, for example by grinding; and (iv) optionally adjusting the suspension pH to between pH 7 to 8, or to about pH 7.5.

The invention further relates to a method of making an oil product, said method comprising: (i) forming a suspension of flax seed, hemp, or chia in water; (ii) heat treating the suspension; (iii) reducing the particle size of the suspension, for example by grinding; (iv) optionally adjusting the suspension pH to between pH 7 to 8, or to about pH 7.5; (v) filtering the suspension and (vi) adjusting the suspension pH to between pH 2 to 3.5, or about pH 2.5; and (vii) obtaining a retentate, preferably by centrifuging.

The invention further relates to a method of making an oil product, said method comprising: (i) forming a suspension of flax seed, hemp, or chia in water; (ii) heat treating the suspension; (iii) reducing the particle size of the suspension, for example by grinding; (iv) optionally adjusting the suspension pH to between pH 7 to 8, or to about pH 7.5; (v) filtering the suspension and (vi) adjusting the suspension pH to between pH 2 to 3.5, or about pH 2.5; and (vii) obtaining a retentate, preferably by centrifuging; and (viii) adding the retentate to a melted fat or melted fat blend to form an oil product.

In one embodiment, a suspension comprising flax seed is formed in part (i).

In one embodiment, mucilage has been substantially removed from the flax seed.

In one embodiment, the flax seed is whole flax seed.

In one embodiment, the average particle size of the suspension in part (iii) is reduced to 200 microns or less, as measured by light scattering.

In one embodiment, the melted fat or melted fat blend has an SFA range between 30-90%.

In one embodiment, the melted fat comprises coconut oil, mango kernel oil, shea stearin, shea butter, sunflower oil or palm oil, preferably coconut oil.

In one embodiment, the melted fat blend comprises shea stearin and sunflower oil.

In one embodiment, the melted fat blend comprises shea stearin and shea butter.

In one embodiment, a suspension of flax seeds are formed in part (i), and the melted fat comprises coconut oil.

In one embodiment, a suspension of flax seeds are formed in part (i), and the melted fat blend comprises shea stearin and sunflower oil.

In one embodiment, a suspension of flax seeds are formed in part (i), and the melted fat blend comprises shea stearin and shea butter.

In one embodiment, the flax seeds are at least 50% dehulled.

The invention further relates to an oil product made by a method according to the invention.

In one embodiment, said product is substantially free of emulsifiers.

In one embodiment, said product is substantially free of antioxidants.

In one embodiment, the product is substantially devoid of hexanyl and/or heptadienal.

In one embodiment, the product is devoid of animal products.

The invention further relates to the use of flax seed which is at least 50% dehulled to make an oil product.

In one embodiment, the oil product is a cooking oil.

### DETAILED DESCRIPTION OF THE INVENTION

The method of making an oil product may comprise the following steps. The first step involves forming a suspension of flax seed, hemp, or chia in liquid, preferably water. Typically, flax seed, hemp, or chia are suspended in water at a ratio between 1:4 to 1:8, or between 1:5 to 1:7, or at about 1:6 (w/v) ratio. Typically, the flax seed, hemp, and chia are not mixed with, for example, non-seed material.

Typically, the suspension is heat treated at between 90 to 100° C., or about 95° C. Heat treatment is typically for between 5 to 25 minutes, or 10 to 20 minutes, or about 15 minutes. The suspension or slurry is then cooled down, for example to between 20 to 60° C., or to between 30 to 50° C., or to about 40° C., or 40° C. or less. Cooling may be performed in an ice bath.

The particle size of the suspension is typically reduced to an average particle size of about 200 microns or less. Preferably, the particle size of the suspension is reduced by grinding. A Thermomix device is suitable for grinding.

The pH of the suspension may be adjusted, for example to between pH 6.5 to 8.5, or to about pH 7 to 8, or to about pH 7.5. The pH may be adjusted using sodium hydroxide solution.

The suspension is then optionally further mixed, for example using a Thermomix. Typically, the suspension is filtered. Typically, the filter has a pore size of less than 500 microns, or between 200 to 500 microns. The filter may be a cheesecloth.

Typically, the pH is adjusted to between pH 1.5 to 4, or to between pH 2 to 3.5, or to between pH 2.5 to 3, or to about pH 2.7. The pH may be adjusted using hydrochloric acid.

Typically, the suspension is centrifuged, for example at about 9000 rpm, for about 20 minutes. Typically, a retentate is obtained. The retentate is typically a cream like substance. The retentate has a viscosity similar to mayonnaise. Typically, the retentate is added to a melted fat or melted fat blend to form an oil product. Typically, the oil product has a hardness similar to ghee fat at 20° C.

The retentate can be added to the melted fat or melted fat blend at a ratio between 1:1 to 1:20, or between 1:5 to 1:15, or at about 1:10 (w/v) ratio when, for example, the retentate is dehulled flax cream and the melted fat is coconut oil.

The retentate can be added to the melted fat or melted fat blend at a ratio between 1:1 to 1:20, or between 1:1 to 1:15, or at about 1.4:10 (w/v) ratio when, for example, the retentate is whole flax cream (or non-dehulled flax cream) and the melted fat is coconut oil.

Typically, the retentate and melted fat or fat blend is mixed, for example using Ultra-Turax. The resulting oil product can be stored at about 4° C. or at ambient conditions.

Typically, the melted fat or melted fat blend has a saturated fatty acid (SFA) range between 25 to 95%, or between 30 to 90%, or between 40 to 80%, or between 50 to 70%, or about 60%.

Typically, the melted fat or melted fat blend comprises coconut oil, mango kernel oil, shea stearin, shea butter, sunflower oil, rapeseed oil, avocado oil, pumpkin seed oil, cocoa fat or palm oil either alone or in combination. Preferably, the melted fat is coconut oil. Typically, the coconut oil has a melting point about 25° C.

Preferably, the melted fat blend is shea stearin and sunflower oil; or shea stearin, shea butter and sunflower oil; or shea stearin and shea butter. The retentate, for example flax retentate, may be incorporated into liquid shea stearin and sunflower oil in a ratio of about 1/2/7 (w/w).

The flax seeds can be whole or dehulled. When the flax seeds are dehulled, they can be for example between 50 to 90% dehulled, or between 50 to 70% dehulled, or about 70% dehulled, or at least 70% dehulled.

The product is preferably made by a method as described herein.

Typically, the product is substantially free of emulsifiers, for example artificial emulsifiers. Typically, the product is substantially free of antioxidants. Typically, the product is substantially free of hydrocolloids. Typically, the product is substantially free of modified starches. Typically, the product is substantially free of additives.

Typically, the product is substantially devoid of an omega 3 marker, for example hexanyl and/or heptadienal. Typically, the product is devoid of animal products, or animal derived products such as egg.

The invention further relates to the use of flax seed, or chia, or hemp to make an oil product as described herein. Preferably, the flax seeds are dehulled, for example between 50 to 70% dehulled, or at least 70% dehulled.

The oil product may be a spoonable oil product. The spoonable oil product may be used, for example, as a cooking oil. The oil product of the invention performs well in the pan at 120° C. No difference can be noted compared to the same products without the retentate (cream).

Typically, the oil product has a shelf-life of greater than six months when stored under ambient conditions, preferably between six months to twelve months.

The definition of certain terminology used within the present application is provided below.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth.

As used herein, “substantially devoid” means being present in an amount less than 0.1 wt %, more preferably 0.05 wt %, more preferably being completely absent.

The term “vegetarian” refers to an edible composition which is entirely devoid of meat or fish products. The term “vegan” refers to an edible composition which is entirely devoid of animal products, or animal derived products. Non-limiting examples of animal products include meat, fish, eggs, milk, and honey.

Unless noted otherwise, all percentages in the specification refer to weight percent, where applicable.

When a composition of product or ingredient is described herein in terms of wt % (weight percent), this means wt % of the total recipe of the related product or ingredient, unless indicated otherwise. For example, ingredient B comprises xwt % of component b means that ingredient B comprises x % of component b by weight of ingredient B. Likewise, product C comprises ywt % of ingredient B means that product C comprises y % of ingredient B by weight of product C.

As used herein, the term “plant protein concentrate” refers to a plant composition comprising a plant protein content from 50% to 79.9%.

As used herein, the term “plant protein isolate” refers to a plant composition comprising a plant protein content from 80.0% to 99.0%.

By “shelf-stable”, it is understood a product which has a shelf-life of several months when stored under ambient conditions. This also generally applies when it is stored under chilled conditions. The term “ambient conditions” refers to temperatures ranging from 15° C. to 25° C., preferably from 20° C. to 22° C. Especially, a shelf-stable product has a shelf-life of at least 3 months, preferably of at least 6 months, more preferably at least 12 months when stored under ambient conditions. These storage temperatures relate to the storage of the product before being commercially obtained by an end consumer. Generally, the end consumer is advised to store the product under the same ambient conditions until consumption, for example in a shelf at room temperature.

Unless defined otherwise, all technical and scientific terms have and should be given the same meaning as commonly understood by one of ordinary skill in the art to which this invention belongs.

### EXAMPLES

By way of example and not limitation, the following examples are illustrative of various embodiments of the present invention.

### Example 1

### Recipe Comprising Dehulled Flax Cream and Coconut Oil

The following recipe was followed to obtain a spoonable coconut oil containing stable omega 3 provided by dehulled flax seeds. Firstly, dehulled flax seeds (50 to 70% dehulled) were suspended in water ratio (1:6, w/v) and heat treated at 95° C. for 15 minutes in a water bath. The resulting slurry was then cooled down to less than 40° C. using an ice bath, and then ground for 2 minutes at speed 8 using Thermomix (Vorwerk, Germany). The pH was then adjusted at pH 7.5 (using 1M HCl or NaOH). The slurry was then mixed at room temperature for 30 minutes with a Thermomix (speed 3) (Vorwerk, Germany) and filtered using a 200 μm-pore size cheesecloth. The pH was then adjusted to 2.7 (using 1M HCl). The solution was centrifuged (9000 rpm for 20 minutes), the retentate was the cream. The final retentate (cream) was incorporated into liquid coconut oil (melting point around 25° C.) ( 1/10 (w/w) ratio) using Ultra-Turax (Ika, Germany) for 5 seconds at 10 000 rpm and then poured into a container and stored.

### Example 2

### Recipe Comprising Whole Flax Cream and Coconut Oil

The following recipe was followed to obtain a spoonable coconut oil containing stable omega 3 provided by whole flax seeds. The whole flax seeds were suspended in water at a ratio of 1:6 (w/v) and heat treated at 95° C. for 15 minutes in a water bath. The resulting slurry was cooled down to less than 40° C. using an ice bath, and then ground for 2 minutes at speed 8 using Thermomix (Vorwerk, Germany). The pH was adjusted to pH 7.5 (using 1M HCl or NaOH). The mixture was then mixed at room temperature for 30 minutes with Thermomix (speed 3) (Vorwerk, Germany) then filtered using a 200 μm-pore size cheesecloth. The pH was adjusted to 2.7 (using 1M HCl). The solution was centrifuged (9000 rpm for 20 minutes), the retentate was the cream. The final cream was incorporated into liquid coconut oil (melting point around 25° C.) (1,4/10 (w/w) ratio) using Ultra-Turax (Ika, Germany) for 5 seconds at 10 000 rpm and then poured into a container and stored.

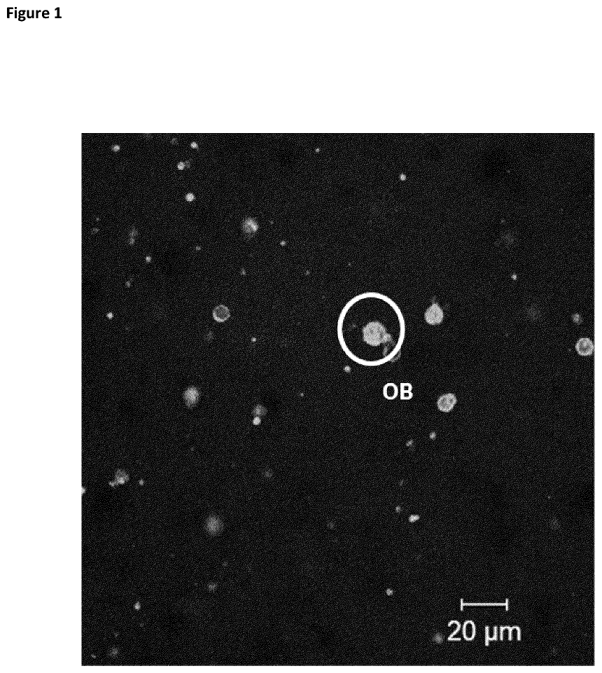

FIG. 1 shows flax oil bodies dispersed in coconut oil. Sample analysis was by CLSM imaging (Nile Red & Fast green). It shows a Confocal Laser Scanning Microscopy image of dehulled flax seeds and coconut oil oil body solution from Example 1. The circle designated as OB highlights an oil body comprising a fat core.

Table 1 shows the stability after 12 months

| | | | T |
|---|---|---|---|
| | | T0 | (12 months) |
| Smell | Sample with | No fishy smell | No fishy smell |
| (sniffing) | coconut | | |
| | oil | | |
| | Samples with | No fishy smell | No fishy smell |
| | flax oil | | |
| | bodies | | |
| Taste | Sample with | Coconut taste | No change |
| | coconut | | in taste |
| | oil | | |
| | Samples with | Coconut taste | No change |
| | flax oil | | in taste |
| | bodies | | |

The results show that, even after 12 months, the omega 3 provided by the flax oil bodies did not give a fishy smell or give a rancid taste.

### Example 3

### Recipe Comprising Flax Oil and Coconut Oil

The same procedure was followed as per examples 1 and 2, except that the flax oil (2%) was incorporated into liquid coconut oil (melting point around 25° C.) ( 2/8 (w/w) ratio) using Ultra-Turax (Ika, Germany) for 5 seconds at 10 000 rpm and then poured into a container and stored.

### Example 4

### Recipe Comprising Dehulled Flax Cream Shea Stearin and Sunflower Oil

The following recipe was followed to obtain a spoonable coconut oil containing stable omega 3 provided by dehulled flax seeds. Firstly, dehulled flax seeds (50-70% dehulled) were suspended in water ratio (1:6, w/v) and heat treated at 95° C. for 15 min in a water bath. The resulting slurry was then cooled down to less than 40° C. using an ice bath, and then ground for 2 minutes at speed 8 using Thermomix (Vorwerk, Germany). The pH was then adjusted to pH 7.5 (using 1M HCl or NaOH). The mixture was then mixed at room temperature for 30 minutes with Thermomix (speed 3) (Vorwerk, Germany) and filtered using a 200 μm-pore size cheesecloth. The pH was then adjusted to pH 2.7 (using 1M HCl). The solution was centrifuged (9000 rpm for 20 minutes), the retentate was the cream. The final cream was incorporated into liquid shea stearin and sunflower oil (1/2/7 (w/w) ratio) using Ultra-Turax (Ika, Germany) for 5 seconds at 10 000 rpm and then poured into a container and stored. At least 20% shea stearin is used to keep the product spoonable.

### Example 5

### Recipe Comprising Dehulled Flax Cream and Shea Stearin and Shea Butter

The following recipe was followed to obtain a spoonable coconut oil containing stable omega 3 provided by dehulled flax seeds. Firstly, dehulled flax seeds (50-70% dehulled) were suspended in water at a ratio 1:6 (w/v) and heat treated at 95° C. for 15 min in a water bath. The resulting slurry was then cooled down to less than 40° C. using an ice bath, and then ground for 2 minutes at speed 8 using Thermomix (Vorwerk, Germany). The pH was then adjusted at pH 7.5 (using 1M HCl or NaOH). The mixture was then mixed at room temperature for 30 minutes with a Thermomix (speed 3) (Vorwerk, Germany) and filtered using a 200 μm-pore size cheesecloth. The pH was then adjusted to pH 2.7 (using 1M HCl). The solution was centrifuged (9000 rpm for 20 minutes), the retentate was the cream. The final cream was incorporated into liquid shea stearin and shea butter (1/2/7 (w/w) ratio) using Ultra-Turax (Ika, Germany) for 5 seconds at 10 000 rpm and then poured into a container and stored.

Table 2 shows stability at room temperature 20° C.

| | | Ex4: dehulled | Ex5: dehulled |
|---|---|---|---|
| | Ex3: standard | flax cream + | flax cream + |
| | flax oil + | shea stearin + | shea stearin + |
| | coconut oil | sunflower oil | shea butter |
| Smell (sniffing) | Fishy smell | No fishy smell | No fishy smell |
| Taste | Rancid | No change in | No change in |
| | | taste | taste |

1. A method of making an oil product, the method comprising:
(i) forming a suspension of flax seed, hemp, or chia in water;
(ii) heat treating the suspension;
(iii) reducing the particle size of the suspension;
(iv) optionally adjusting the pH of the suspension to between pH 7 to 8;
(v) filtering the suspension;
(vi) adjusting the pH of the filtered suspension to between pH 2 to 3.5;
(vii) obtaining a retentate; and
(viii) adding the retentate to a melted fat or melted fat blend to form the oil product.

2. The method according to claim 1, wherein the suspension formed in step (i) comprise flax seed.

3. The method according to claim 2, wherein mucilage has been substantially removed from the flax seed.

4. The method according to claim 2, wherein the flax seed is whole flax seed.

5. The method according to claim 1, wherein the average particle size of the suspension in step (iii) is reduced to 200 microns or less, as measured by light scattering.

6. The method according to claim 1, wherein the melted fat or melted fat blend has an SFA range between 30-90%.

7. The method according to claim 1, wherein the melted fat comprises coconut oil, mango kernel oil, shea stearin, shea butter, sunflower oil or palm oil.

8. The method according to claim 1, wherein the melted fat blend comprises
a. a combination of shea stearin and sunflower oil; or
b. a combination of shea stearin and shea butter.

9. The method according to claim 1, wherein the suspension formed in step (i) comprises flax seeds, and the melted fat or melted fat blend comprises
c. coconut oil; or
d. a combination of shea stearin and sunflower oil; or
e. a combination of shea stearin and shea butter.

10. The method according to claim 2, wherein the flax seeds are at least 50% dehulled.

11. An oil product made by a method comprising:
(i) forming a suspension of flax seed, hemp, or chia in water;
(ii) heat treating the suspension;
(iii) reducing the particle size of the suspension;
(iv) optionally adjusting the pH of the suspension to between pH 7 to 8;
(v) filtering the suspension;
(vi) adjusting the pH of the filtered suspension to between pH 2 to 3.5;
(vii) obtaining a retentate; and
(viii) adding the retentate to a melted fat or melted fat blend to form the oil product.

12. The oil product according to claim 11, wherein the oil product is substantially free of emulsifiers and/or antioxidants.

13. The oil product according to claim 11, wherein the oil product is substantially devoid of hexanyl and/or heptadienal.

14. The oil product according to claim 11, wherein the oil product is devoid of animal products.

15. (canceled)

16. The method according to claim 1, wherein the reducing the particle size of the suspension in step (iii) comprises grinding.

17. The method according to claim 1, wherein the obtaining the retentate in step (vii) comprises centrifuging.

18. The method according to claim 1, wherein the oil product is substantially free of emulsifiers and/or antioxidants.

19. The method according to claim 1, wherein the oil product is substantially devoid of hexanyl and/or heptadienal.

20. The method according to claim 1, wherein the oil product is devoid of animal products.
